(19) United States
(12) Patent Application Publication
(10) Pub. No.: US 2025/0059890 A1
(43) Pub. Date: Feb. 20, 2025

(54) GROUT PLUG WITH GASKET FOR POCKET FORMER

(71) Applicant: Felix SORKIN, Stafford, TX (US)

(72) Inventor: Felix SORKIN, Stafford, TX (US)

(21) Appl. No.: 18/234,102

(22) Filed: Aug. 15, 2023

(51) Int. Cl. E21D 20/02

(52) U.S. Cl. CPC E21D 20/028

(57) ABSTRACT

A grout plug with a gasket. The plug can be cylindrical with one or more cavities therein.

### FIELD OF THE DISCLOSURE

The present disclosure relates to a removable grout plug with a gasket.

### BACKGROUND

Many structures are built using concrete, including for instance, buildings, parking structures, apartments, condominiums, hotels, mixed-use structures, casinos, hospitals, medical buildings, government buildings, research/academic institutions, industrial buildings, malls, roads, bridges, pavement, tanks, reservoirs, silos, sports courts, and other structures.

Prestressed concrete is structural concrete in which internal stresses are introduced to reduce potential tensile stresses in the concrete resulting from applied loads; prestressing may be accomplished by post-tensioned prestressing or pre-tensioned prestressing. In post-tensioned prestressing, a tension member is tensioned after the concrete has attained a desired strength by use of a post-tensioning tendon. The post-tensioning tendon may include for example and without limitation, anchor assemblies, the tension member, and sheathes. Traditionally, a tension member is constructed of a material that can be elongated and may be a single or a multi-strand cable. Typically, the tension member may be formed from a metal or composite material, such as reinforced steel. The post-tensioning tendon conventionally includes an anchor assembly at each end. The posttensioning tendon is fixedly coupled to a fixed anchor assembly positioned at one end of the post-tensioning tendon, the “fixed-end”, and stressed at the stressed anchor assembly positioned at the opposite end of the posttensioning tendon, the “stressing-end” of the post-tensioning tendon.

A pocket former may be used to prevent or restrict concrete from filling in the area between the stressing-end anchor and the concrete form used to form the concrete member to allow access to the stressing-end of the tendon once the concrete member is poured. As understood in the art, the concrete form is a form or mold into which concrete is poured or otherwise introduced to give shape to the concrete member as it sets or hardens, thus forming the concrete member. Once the concrete has sufficiently hardened and the concrete form is removed, the pocket former is removed from the concrete member. In certain conventional uses, pocket formers are frustoconical in shape to facilitate removal from the concrete member. Conventionally, once the tendon is stressed, the pocket formed by the pocket former is filled with a material such as a cementitious grout or concrete to, for example, provide fire protection and corrosion protection.

Grout plugs are conventionally used in concert with pocket formers to create a secure channel through which tendons can be threaded. However, conventional grout plugs are often secured to pocket formers without any gasket or rubber ring. Thus, there is a present need to provide a grout plug with a gasket to improve the fit of the grout plug.

### SUMMARY OF THE DISCLOSURE

In some aspects, the techniques described herein relate to a grout plug for use in combination with a pocket former in a post-tensioning system, the grout plug including: a cylindrical body having a narrow end and a wide end; an interior tube extending between the narrow end and the wide end, the interior tube being of a uniform size and shape; an exterior tube surrounding the interior tube, the exterior tube having a greater diameter at the wide end than at the narrow end, and sloping continuously from the narrow end to the wide end; a gasket extending radially from the exterior tube between the narrow end and the wide end; a lip extending axially from the narrow end of the grout plug; and one or more cavities of equal size and shape at the wide end, the cavities being separated by one or more dividers extending radially from the interior tube to the exterior tube, wherein the depth of the cavities terminates halfway through the grout plug.

In some aspects, the techniques described herein relate to a grout plug including: a cylindrical body; an interior tube; an exterior tube; and a gasket extending radially from the exterior tube.

In some aspects, the techniques described herein relate to a grout plug including: a cylindrical body; and a gasket extending radially from the exterior of the body.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIGS. 1A and 1B illustrate a grout lock with a gasket according to an exemplary embodiment.

FIGS. 2A and 2B illustrate a grout lock with a gasket according to an exemplary embodiment.

FIG. 3 illustrates a grout lock with a gasket according to an exemplary embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments.

The present embodiments describe a grout plug in conjunction with a pocket former. The pocket former is a specialized tool used in post-tensioning systems to create a cavity or pocket within the concrete structure. This pocket former is designed to improve the quality and durability of the post-tensioning tendons, which are the tension members used to reinforce the concrete.

The pocket former can consist of two components: the pocket former itself and a grout plug. The pocket former is a device that is placed within the concrete form to create the desired pocket or void. The grout plug is a separate component that has an interior concave surface, which means it is curved inward.

The unique concept behind the system is that the grout plug provides a mechanical bond to hold the grout plug securely in place within the pocket former. This is particularly beneficial in challenging conditions where the stressing pocket may be wet, dirty, greasy, or have torch residue.

The interior concave surface of the grout plug creates a shear key, which means it has a shape that helps lock it in place and resist movement. The grout plug slides into position on the pocket former, holding it firmly in place. This mechanical bond ensures that the grout plug remains tightly secured against the surrounding concrete, even in less than ideal conditions.

By using the pocket former with a grout lock, the post-tensioning tendons are better protected, and the overall quality and longevity of the concrete structure are enhanced. The system provides a reliable and secure method for holding the grout plug in place, improving the performance and effectiveness of the post-tensioning system in various conditions.

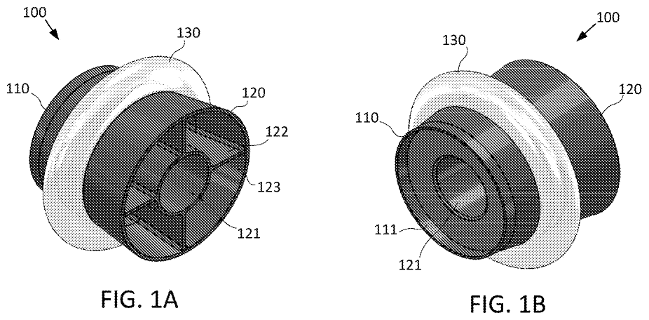

FIGS. 1A and 1B illustrate a grout plug 100 with a gasket 130 according to an exemplary embodiment. The grout plug 100 can be cylindrical in shape with two ends, a narrow end 110 and a wide end 120, resulting in a tapered exterior that continuously slopes from the narrow end 110 to the wide end 120. This tapering shape allows for easy insertion into a pocket former or concrete member. Positioned between the narrow end 110 and the wide end 120 is a gasket 130 made of materials such as rubber, silicone, polymer, or other suitable materials. The gasket 130 extends radially from the grout plug 100, creating a sealing interface between the grout plug 100 and the pocket former or concrete member. Within the grout plug 100, there is an interior tube 121 that maintains a uniform shape and size from the narrow end 110 to the wide end 120, although in some embodiments, the interior tube 121 may have varying shapes and sizes to accommodate specific use cases. The wide end 120 features one or more cavities 122, as shown in FIG. 1A, which are separated by dividers 123 extending from the interior tube 121 to the exterior of the grout plug 100. The cavities 122 extend partially into the grout plug 100 before terminating, typically halfway through the grout plug 100. It is worth noting that alternative embodiments may include a different number of cavities than depicted in FIG. 1A. At the narrow end 110, there is a lip 111 that extends axially from the grout plug 100, providing additional structural support. In certain embodiments, the lip 111 may be beveled, enhancing ease of insertion and compatibility.

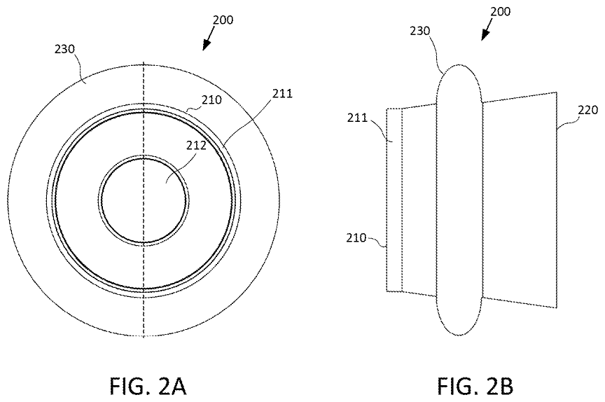

FIGS. 2A and 2B illustrate a top-down view and a side view of the grout plug 200. In FIG. 2A, the gasket 230 extends radially from the grout plug 200, ensuring a tight seal between the grout plug 200 and the pocket former or concrete member. The narrow end 210, along with the lip 211, surrounds the inner tube 212, providing stability and preventing grout leakage. The gasket 230 is positioned between the narrow end 210 and the wide end 220, contributing to the overall sealing functionality of the grout plug 200.

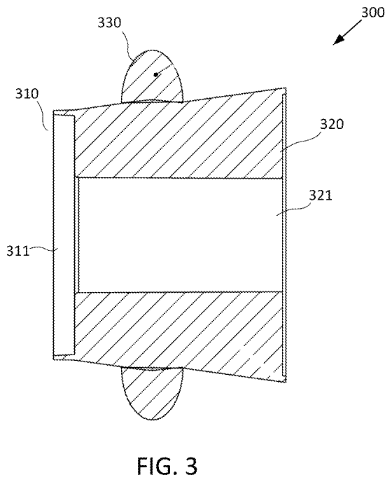

FIG. 3 illustrates a cross-section of grout plug 300. The grout plug 300 features a narrow end 310 and a wide end 320. Within the grout plug 300, an inner tube 321 runs through its entire length, extending from the narrow end 310 to the wide end 320. This inner tube 321 serves as a conduit for grout injection and distribution within the concrete member. Surrounding the grout plug 300 is the gasket 330, which ensures a reliable seal and prevents grout from escaping. At the narrow end 310, a lip 311 is present, providing structural reinforcement and facilitating secure positioning of the grout plug 300 within the pocket former or concrete member.

In some aspects, the techniques described herein relate to a grout plug for use in combination with a pocket former in a post-tensioning system, the grout plug including: a cylindrical body having a narrow end and a wide end; an interior tube extending between the narrow end and the wide end, the interior tube being of a uniform size and shape; an exterior tube surrounding the interior tube, the exterior tube having a greater diameter at the wide end than at the narrow end, and sloping continuously from the narrow end to the wide end; a gasket extending radially from the exterior tube between the narrow end and the wide end; a lip extending axially from the narrow end of the grout plug; and one or more cavities of equal size and shape at the wide end, the cavities being separated by one or more dividers extending radially from the interior tube to the exterior tube, wherein the depth of the cavities terminates halfway through the grout plug.

In some aspects, the techniques described herein relate to a grout plug, wherein the gasket is made of a flexible material selected from the group consisting of rubber, silicone, or elastomeric material.

In some aspects, the techniques described herein relate to a grout plug, wherein the exterior tube has a textured surface.

In some aspects, the techniques described herein relate to a grout plug, wherein the lip has a beveled edge.

In some aspects, the techniques described herein relate to a grout plug, wherein the four dividers are evenly spaced around the circumference of the wide end.

In some aspects, the techniques described herein relate to a grout plug, wherein the cavities at the wide end are tapered, with a larger opening at the exterior surface and a smaller opening at the interior tube.

In some aspects, the techniques described herein relate to a grout plug, wherein the grout plug is made of a material selected from the group consisting of plastic, composite materials, or metal alloys.

In some aspects, the techniques described herein relate to a grout plug, wherein the narrow end of the grout plug is configured to securely fit within a corresponding recess of a pocket former.

In some aspects, the techniques described herein relate to a grout plug, wherein the grout plug further includes a locking mechanism that engages with a corresponding feature in a pocket former.

In some aspects, the techniques described herein relate to a grout plug including: a cylindrical body; an interior tube; an exterior tube; and a gasket extending radially from the exterior tube.

In some aspects, the techniques described herein relate to a grout plug, wherein the grout plug includes alignment indicators that align with corresponding marks on a pocket former.

In some aspects, the techniques described herein relate to a grout plug, wherein the grout plug and the pocket former are designed to accommodate different sizes or configurations of post-tensioning tendons.

In some aspects, the techniques described herein relate to a grout plug, wherein the grout plug and the pocket former are integrated as a single unit.

In some aspects, the techniques described herein relate to a grout plug, wherein grout plug further includes one or more cavities in the wide end of the grout plug are shaped to accommodate anchor assemblies or other components associated with post-tensioning tendons.

In some aspects, the techniques described herein relate to a grout plug, wherein the grout plug is color-coded or labeled with indicia indicating its size, compatibility, or specific application.

In some aspects, the techniques described herein relate to a grout plug, wherein the gasket is made of a flexible material selected from the group consisting of rubber, silicone, or elastomeric material.

In some aspects, the techniques described herein relate to a grout plug, wherein the grout plug is made of a material selected from the group consisting of plastic, composite materials, or metal alloys.

In some aspects, the techniques described herein relate to a grout plug, wherein the grout plug further includes a locking mechanism that engages with a corresponding feature in a pocket former.

In some aspects, the techniques described herein relate to a grout plug, wherein the exterior tube has a textured surface.

In some aspects, the techniques described herein relate to a grout plug including: a cylindrical body; and a gasket extending radially from the exterior of the body.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

Further, it is to be understood that the terminology used herein is for the purpose of describing particular embodiments only and is not intended to be limiting. The terms “a” or “an” as used herein, are defined as one or more than one. The term “plurality” as used herein, is defined as two or more than two. The term “another” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper,” “lower,” “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

The preceding description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

What is claimed is:

1. A grout plug for use in combination with a pocket former in a post-tensioning system, the grout plug comprising:
a cylindrical body having a narrow end and a wide end;
an interior tube extending between the narrow end and the wide end, the interior tube being of a uniform size and shape;
an exterior tube surrounding the interior tube, the exterior tube having a greater diameter at the wide end than at the narrow end, and sloping continuously from the narrow end to the wide end;
a gasket extending radially from the exterior tube between the narrow end and the wide end;
a lip extending axially from the narrow end of the grout plug;
and one or more cavities of equal size and shape at the wide end, the cavities being separated by one or more dividers extending radially from the interior tube to the exterior tube, wherein the depth of the cavities terminates halfway through the grout plug.

2. The grout plug of claim 1, wherein the gasket is made of a flexible material selected from the group consisting of rubber, silicone, or elastomeric material.

3. The grout plug of claim 1, wherein the exterior tube has a textured surface.

4. The grout plug of claim 1, wherein the lip has a beveled edge.

5. The grout plug of claim 1, wherein the four dividers are evenly spaced around the circumference of the wide end.

6. The grout plug of claim 1, wherein the cavities at the wide end are tapered, with a larger opening at the exterior surface and a smaller opening at the interior tube.

7. The grout plug of claim 1, wherein the grout plug is made of a material selected from the group consisting of plastic, composite materials, or metal alloys.

8. The grout plug of claim 1, wherein the narrow end of the grout plug is configured to securely fit within a corresponding recess of the pocket former.

9. The grout plug of claim 1, wherein the grout plug further comprises a locking mechanism that engages with a corresponding feature in the pocket former.

10. A grout plug comprising:
a cylindrical body;
an interior tube;
an exterior tube; and
a gasket extending radially from the exterior tube.

11. The grout plug of claim 10, wherein the grout plug includes alignment indicators that align with corresponding marks on a pocket former.

12. The grout plug of claim 10, wherein the grout plug and the pocket former are designed to accommodate different sizes or configurations of post-tensioning tendons

13. The grout plug of claim 10, wherein the grout plug and the pocket former are integrated as a single unit.

14. The grout plug of claim 10, wherein the grout plug further comprises one or more cavities in the wide end of the grout plug are shaped to accommodate anchor assemblies or other components associated with post-tensioning tendons.

15. The grout plug of claim 10, wherein the grout plug is color-coded or labeled with indicia indicating its size, compatibility, or specific application.

16. The grout plug of claim 10, wherein the gasket is made of a flexible material selected from the group consisting of rubber, silicone, or elastomeric material.

17. The grout plug of claim 10, wherein the grout plug is made of a material selected from the group consisting of plastic, composite materials, or metal alloys.

18. The grout plug of claim 10, wherein the grout plug further comprises a locking mechanism that engages with a corresponding feature in a pocket former.

19. The grout plug of claim 10, wherein the exterior tube has a textured surface.

20. A grout plug comprising:
a cylindrical body; and
a gasket extending radially from the exterior of the body.
